(19) United States
(12) Patent Application Publication
(10) Pub. No.: US 2013/0262006 A1
(43) Pub. Date: Oct. 3, 2013

(54) White LED Quality Inspection Method and Device

(71) Applicant: NATIONAL APPLIED RESEARCH LABORATORIES, (US)

(72) Inventors: Chun-Li CHANG, Chiayi County (TW); Kuo-Cheng HUANG, Hsinchu City (TW); Ching-Ching YANG, Hsinchu City (TW); Wen-Hong WU, Kaohsiung City (TW); Han-Chao CHANG, Hsinchu City (TW)

(73) Assignee: NATIONAL APPLIED RESEARCH LABORATORIES, Hsinchu (TW)

(21) Appl. No.: 13/749,664

(22) Filed: Jan. 24, 2013

(30) Foreign Application Priority Data
Mar. 29, 2012 (TW) 101110976

(51) Int. Cl. G01J 3/50; G06F 17/00

(52) U.S. Cl. CPC G01J 3/505; G06F 17/00
USPC 702/81

(57) ABSTRACT

A white LED quality inspection method includes steps as follows. A steady current is supplied to a LED by a rated voltage supply unit for generation of a stable light spot from the LED; a stable light spot is received by a photosensor of a luminous intensity sensing unit and transformed to digital information; the digital information is received by a preprocessing unit and transformed to pixel information; the pixel information is received by a calculation unit to calculate a Yellow Ring Index of each pixel in the pixel information.

### BACKGROUND OF THE INVENTION

1. Field of the Invention

The present invention relates to a white LED quality inspection method and device, especially a method and device used to inspect yellow hues in different areas of a white LED's light spot.

2. Description of the Prior Art

In recent years, astounding advances of technologies and techniques with respect to lighting equipment have brought people convenient illumination as well as creation of visual aesthetics and artistry in the course from fire to tungsten lamp, fluorescent lamp, LED (Light Emitting Diode) or OLED (Organic Light Emitting Diode). For the most common lighting equipment, e.g., fluorescent lamp and LED, LED features power saving, luminous efficiency and even multiple functions (e.g., back light unit and optical pickup head) and has been adopted more extensively than the fluorescent lamp. The types of LEDs are numerous. As technologies develop, LEDs have evolved from a conventional low-luminance red LED to various high-luminance monochromatic LEDs and even the blue or the purple LED which can be mass-produced recently. This evolution in LEDs has realized white light which is not only mixed by RGB LED but also emitted by a single blue or purple LED with fluorescent agents mixed.

High precision is necessary for a process to add fluorescent agents into a blue or purple LED because of excessive light transmittance or bluer light spots arising from larger fluorescent particles (or insufficient fluorescent agents) or yellower light spots or low luminance attributed to smaller fluorescent particles and thus insufficient light transmittance. In other words, uniform crystalline grains and fluorescent agents are indispensable to a process for manufacture of good white LEDs. Despite various parameters such as luminous flux, luminous intensity, dominant wavelength, color temperature, luminance, and color rendering as performance indices in tests of a white LED available in the market, these performance indices usually present means for one complete area of a white LED's light spot rather than characteristics of one specific area. Accordingly, it is a critical issue to develop one standard to effectively analyze, quantify and assess yellow hues in different areas of a white LED's light spot and to automatically generate real-time results as important information for industrial technologies and references to evaluate and improve techniques in the future.

### SUMMARY OF THE INVENTION

The present invention is intended for presenting a systematic structure and method, especially a white LED quality inspection method and device which is able to scientifically, automatically and effectively analyze and quantify yellow hues of a white LED's light spot. To realize the above purpose, the present invention adopts the following technical measures:

A white LED quality inspection method comprising the steps of: supplying a steady current to a white LED by a rated voltage supply unit to generate of a stable light spot; receiving said stable light spot by a photosensor of a luminous intensity sensing unit and transforming said stable light spot to a digital information; receiving said digital information by a preprocessing unit and transforming said digital information to a pixel information; and receiving said pixel information by a calculation unit to calculate a Yellow Ring Index of each pixel in said pixel information.

In the present invention, wherein said calculation unit is a microprocessor and receives said pixel information to calculate said Yellow Ring Index of each pixel based on formulas as the following:

$${YRI}_{i , j} = f ( {Y}_{i , j} , {I}_{i , j} )$$

$$f ( Y , {I}_{i , j} ) = {Y}_{0} \times {I}_{0 , i , j}$$

$${Y}_{0 , i , j} = 1 - \frac{{B}_{i , j}}{{2}^{n}}$$

$${I}_{0 , i , j} = \frac{( {R}_{i , j} + {G}_{i , j} + {B}_{i , j} )}{3}$$

$$0 \leq {R}_{i , j} , {G}_{i , j} , {B}_{i , j} \leq {2}^{n}$$

wherein, YRI_{i,j} as said Yellow Ring Index of each pixel is the function of ƒ(Y_{i,j},I_{i,j}); R ,G, and B mean three primary colors (red, green and blue) of each pixel in said pixel information; n depends on a resolution scope of said luminous intensity sensing unit; i, j are a horizontal coordinate and a vertical coordinate of each pixel in said pixel information, respectively.

In the present invention, wherein said white LED is installed on a support which depends on said luminous intensity sensing unit to adjust heights and angles of said white LED.

In the present invention, further comprising steps of: installing a luminous intensity attenuation unit in front of said luminous intensity sensing unit to attenuate luminance of said stable light spot out of said white LED.

In the present invention, further comprising steps of: concentrating and projecting said stable light spot on said photosensor by means of an optical lens unit of said luminous intensity sensing unit.

In the present invention, further comprising steps of: receiving said Yellow Ring Index of each pixel by a yellow hue determination unit of said calculation unit to determine whether said Yellow Ring Index out of a standard value.

A white LED quality inspection device, comprising: a white LED, coupled to a rated voltage supply unit and the white LED supplied a steady current to said white LED to generate a stable light spot; a luminous intensity sensing unit, further comprised a photosensor which received said stable light spot from said white LED and transformed said stable light spot to a digital information; a preprocessing unit, coupled to said luminous intensity sensing unit and received said digital information which will be further transformed to a pixel information; and a calculation unit, coupled to said preprocessing unit to receive said pixel information and calculate Yellow Ring Index of each pixel in said pixel information.

In the present invention, wherein said calculation unit is a microprocessor and receives said pixel information to calculate said Yellow Ring Index of each pixel based on formulas as following:

$${YRI}_{i , j} = f ( {Y}_{i , j} , {I}_{i , j} )$$

$$f ( Y , {I}_{i , j} ) = {Y}_{0} \times {I}_{0 , i , j}$$

$${Y}_{0 , i , j} = 1 - \frac{{B}_{i , j}}{{2}^{n}}$$

$${I}_{0 , i , j} = \frac{( {R}_{i , j} + {G}_{i , j} + {B}_{i , j} )}{3}$$

$$0 \leq {R}_{i , j} , {G}_{i , j} , {B}_{i , j} \leq {2}^{n}$$

wherein, YRI_{i,j} as said Yellow Ring Index of each pixel is the function of ƒ(Y_{i,j}, I_{i,j}); R, G, and B mean three primary colors (red, green and blue) of each pixel in said pixel information; n depends on a resolution scope of said luminous intensity sensing unit; i, j are a horizontal coordinate and a vertical coordinate of each pixel in said pixel information, respectively.

In the present invention, wherein said white LED is installed on a support which depends on said luminous intensity sensing unit to adjust heights and angles of said white LED.

In the present invention, further comprises a luminous intensity attenuation unit which is installed in front of said luminous intensity sensing unit to attenuate luminance of said stable light spot out of said white LED.

In the present invention, wherein said luminous intensity sensing unit further comprises an optical lens unit which concentrates and projects said stable light spot on said photosensor.

In the present invention, wherein said calculation unit further comprises a yellow hue determination unit which determines whether said Yellow Ring Index is out of specification.

To cope with disadvantages of current techniques failing in analyzing, quantifying and judging effective areas of yellow hues of a white LED's spot light, the present invention provides a white LED quality inspection method and device which covers the following advantages with above descriptions summarized:

(1) Contrary to conventional techniques which focus on inspections of average properties of a LED's light spot only, the present invention shows competence to analyze, quantify and judge yellow hues in different areas of a white LED's light spot and promotes a process.

(2) The present invention depends on brief steps to complete automatic real-time analyses and calculations for different areas of an LED's light spot without complex optical paths and numerous operations.

(3) The present invention needs not complicated equipment to completely test yellow hues of a LED's light spot based on a simply structure including general image devices and computers.

### BRIEF DESCRIPTION OF THE DRAWINGS

FIG. 1 is the block diagram for the present invention of a white LED quality inspection method and device;

FIG. 2A is a contour plot for luminous intensity vs. blue light intensity;

FIG. 2B is an example for development of segments;

FIG. 3 is the flow diagram for the present invention of a white LED quality inspection method and device;

FIG. 4 illustrates the first embodiment for the present invention of a white LED quality inspection method and device;

FIG. 5 illustrates the second embodiment for the present invention of a white LED quality inspection method and device.

### DETAILED DESCRIPTION OF THE PREFERRED EMBODIMENT

The present disclosure presents a systematic structure and method, especially a white LED quality inspection method and device which is able to scientifically, automatically and effectively analyze and quantify yellow hues of a light spot from a white LED. To realize the above purpose, the present invention adopts the following technical measures:

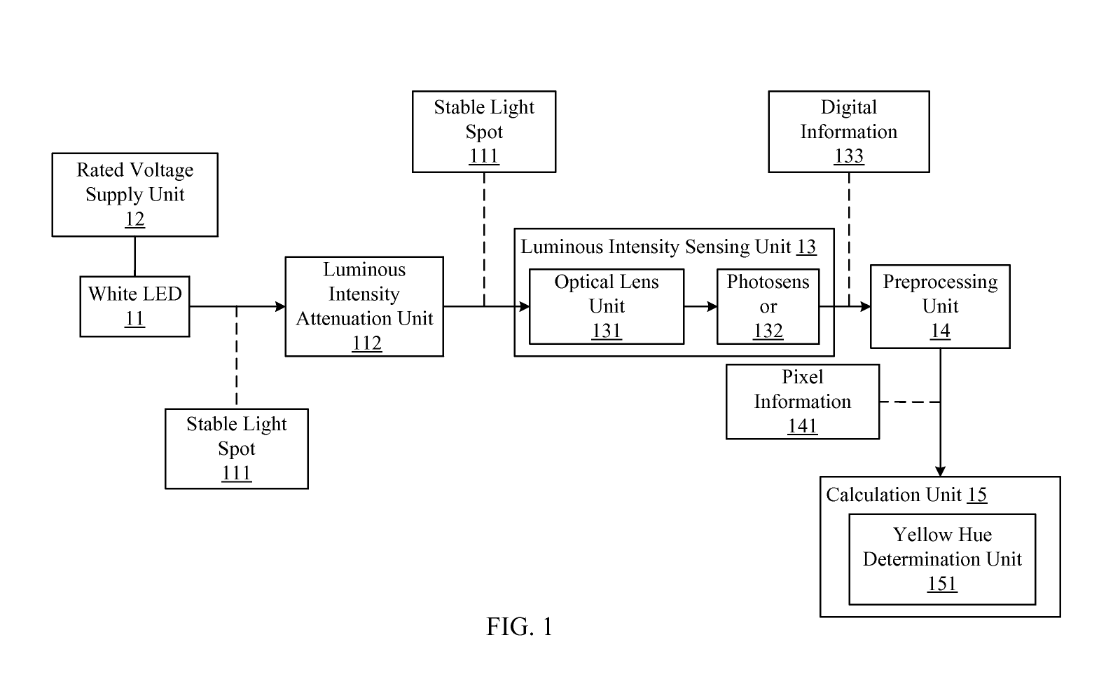

Referring to FIG. 1 which illustrates the block diagram for the present invention of a white LED quality inspection method and device. As shown in FIG. 1, the present invention of a white LED quality inspection method and device comprises a white LED 11, a luminous intensity sensing unit 13, a preprocessing unit 14 and a calculation unit 15. The white LED 11 links a rated voltage supply unit 12 which offers the white LED 11 a steady current for generation of a stable light spot 111 from the white LED 11. The white LED 11 is a white light emitting diode manufactured with difference processes, for instance, RGB LED or blue LED with Ce³⁺: YAG phosphor mixed or UV LED with two types of phosphors mixed such as Eu emitting red and blue light and zinc sulfide with Cu and Al emitting green light. The luminous intensity sensing unit 13 consists of an optical lens unit 131 and a photosensor 132 wherein the optical lens unit 131 is used to concentrate, focus and project the stable light spot 111 on the photosensor 132 and the photosensor 132 can be Charge-Coupled Device (CCD) or Complementary Metal-Oxide-Semiconductor (CMOS) which transforms light into electricity and analog signals to digital signals. A luminous intensity attenuation unit 112 which is installed in front of the luminous intensity sensor 13 is intended for attenuating luminance of the stable light spot 111 from the white LED 11 and preventing a central area of the stable light spot 111 from strong luminance or the photosensor 132 from supersaturation with white light projected on the photosensor 132, that is, the luminous intensity attenuation unit 112 is able to uniformly reduce contrast of the stable light spot 111. The luminous intensity attenuation unit 112 can be a neutral density filter or a screen at a proper distance from the white LED 11 for the stable light spot 111 out of the white LED 11 projected on the screen and reduction in luminance of the stable light spot 111. The preprocessing unit 14 which links the luminous intensity sensing unit 13 is used to receive signals from the photosensor 132 of the luminous intensity sensor 13 and transform signals to an image or a numerical figure with a plurality of pixels. The calculation unit 15 which is a microprocessor links the preprocessing unit 14 and comprises a yellow hue determination unit 151.

With a steady current supplied to the white LED 11 from the rated voltage supply unit 12, a stable light spot 111 is emitted from the white LED 11 and uniformly attenuated by the luminous intensity attenuation unit 112. The stable light spot 111 with its average intensity attenuated is concentrated and focused by the optical lens unit 131 of the luminous intensity sensing unit 13 and projected on the photosensor 132 of the luminous intensity sensing unit 13. The stable light spot 111 received by the photosensor 132 is transformed to analog signals and further digital information 133 which can be delivered to the preprocessing unit 14. The digital information 133 received by the preprocessing unit 14 will be transformed to pixel information 141 and conveyed to the calculation unit 15. With the pixel information 141 received by the calculation unit 15, a Yellow Ring Index (not shown in the figure) of each pixel in the pixel information 141 will be calculated and further evaluated by a yellow hue determination unit 151 for any Yellow Ring Index out of specification. The specification should refer to instructions of a supplier or a lab. Furthermore, a Yellow Ring Index of each pixel in the pixel information 141 which is brought to the calculation unit 15 is based on formulas as follows:

$${YRI}_{i , j} = f ( {Y}_{i , j} , {I}_{i , j} )$$

$$f ( Y , {I}_{i , j} ) = {Y}_{0} \times {I}_{0 , i , j}$$

$${Y}_{0 , i , j} = 1 - \frac{{B}_{i , j}}{{2}^{n}}$$

$${I}_{0 , i , j} = \frac{( {R}_{i , j} + {G}_{i , j} + {B}_{i , j} )}{3}$$

$$0 \leq {R}_{i , j} , {G}_{i , j} , {B}_{i , j} \leq {2}^{n}$$

where YR_{i,j} as each pixel's Yellow Ring Index is the function of ƒ(Y_{i,j}, I_{i,j}); R ,G, and B mean three primary colors (red, green and blue) of each pixel in the pixel information 141; n=8, 10, 12, 14, or 16 depends on a resolution scope of the luminous intensity sensing unit 13; i, j are a horizontal coordinate and a vertical coordinate of each pixel in the pixel information 141, respectively.

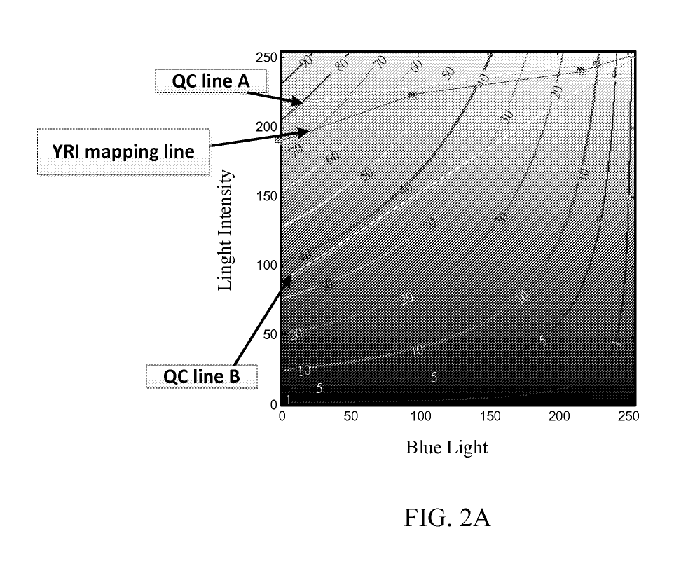

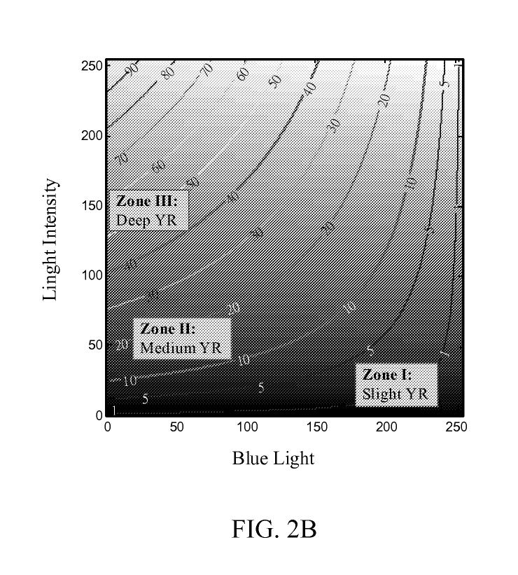

Referring to FIG. 2A which illustrates a contour plot for luminous intensity vs. blue light intensity wherein all degrees of yellow hues are defined by a supplier or a lab. As shown in FIG. 2A in Appendix, there are three sections defined: Section 1 (pale yellow); Section 2 (medium yellow); Section 3 (dark yellow). After every yellow hue corresponding to each pixel in the pixel information 141 is calculated by the calculation unit, all values can be quantified by referring to FIG. 2A in Appendix and constitute Yellow Ring Indices (YRI) at each section. Referring to FIG. 2B in Appendix which illustrates an example for development of segments wherein an upper limit, a YRI line, and a lower limit are determined by a supplier or a lab and those values used in these segments (e.g., YRI line in FIG. 2B of Appendix) are preset into the yellow hue determination unit 151 as criteria to decide any YRI in each section out of the upper or the low limit. It can be seen from above descriptions that the present invention of a white LED quality inspection method and device has one procedure to calculate real-time yellow hue values of the white LED 11 in each section and immediately decide a light spot out of specification.

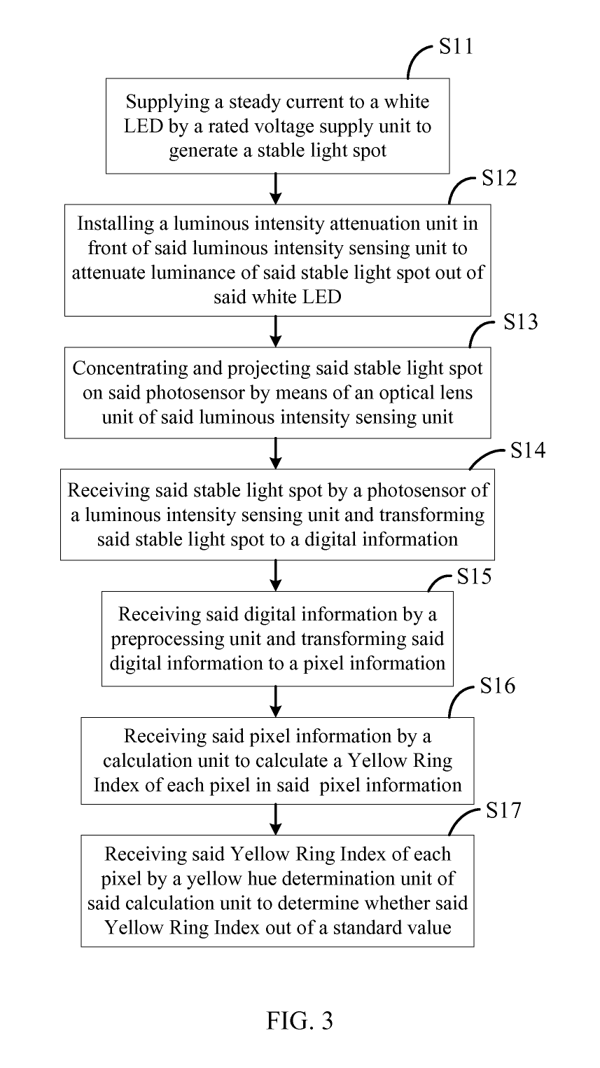

According to above descriptions, the present invention of a white LED quality inspection method and device presents a real-time calculation system as one tool to quantify yellow hue values in each section for a white LED. Referring to FIG. 3 which illustrates the flow diagram for the present invention of a white LED quality inspection method and device wherein the flow diagram can substantially describe spirit of the present invention as follows:

S11: A steady current is supplied to a white LED by a rated voltage supply unit for generation of a stable light spot from the white LED;

S12: A luminous intensity attenuation unit is installed in front of the luminous intensity sensing unit to attenuate luminance of the stable light spot of the white LED;

S13: The stable light spot is concentrated and projected on a photosensor of the luminous intensity sensing unit by means of an optical lens unit of the luminous intensity sensing unit;

S14: The stable light spot is received by the photosensor of the luminous intensity sensing unit and transformed to digital information;

S15: The digital information is received by a preprocessing unit and transformed to pixel information;

S16: The pixel information is received by a calculation unit which is used to calculate YRI of each pixel in the pixel information;

S17: Each pixel's YRI is received by a yellow hue determination unit of the calculation unit to determine any YRI out of specification.

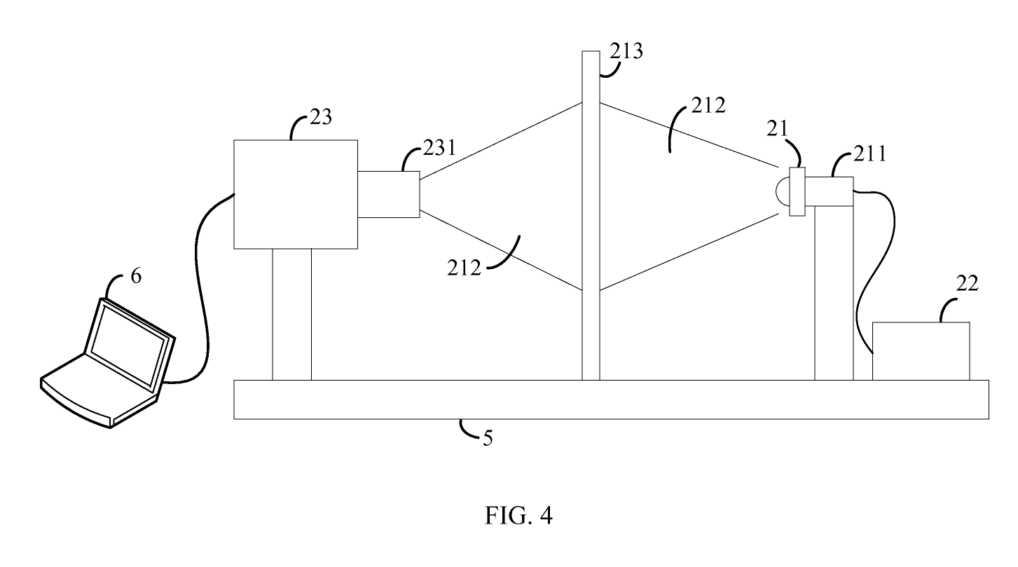

Referring to FIG. 4 which illustrates the first embodiment for the present invention of a white LED quality inspection method and device. As shown in FIG. 4, the present invention of a white LED quality inspection method and device comprises a white LED 21, a power supply 22, a neutral density filter 213, an image capture device 23 and a notebook computer 6 wherein the white LED 21, the power supply 22, the neutral density filter 213 and the image capture device 23 are installed on an optical table 5. The white LED 21 links the power supply 22 which supplies stable voltage and current necessary to emission of white light 212 from the white LED 21. As one component for installation of the white LED 21, a support 211 allows heights and angles of the white LED 21 to be adjusted by a position of a lens 231 of the image capture device 23 for a central point of the white light 212 from the white LED 21 aligning the center of the lens 231 and the white light 212 received by the lens 231. A neutral density filter 213 is installed between the image capture device 23 and the white LED 21 in order to uniformly attenuate luminance of the white light 212 out of the white LED 21 and prevent light signals received by a photosensor (not shown in the figure) in the image capture device 23 from supersaturation or the photosensor from damage due to strong light. When the white light 212 is received by the image capture device 23, light signals will be transformed to analog signals and further digital signals by the image capture device 23 and conveyed to the notebook computer 6. The notebook computer 6 comprises an image preprocessing module, a yellow hue calculation module and a yellow hue determination module (not shown in the figure) wherein the image preprocessing module transforms received digital signals to pixel information, the yellow hue calculation module calculates YRI of each pixel in the pixel information, and the yellow hue determination module judges any YRI out of specification.

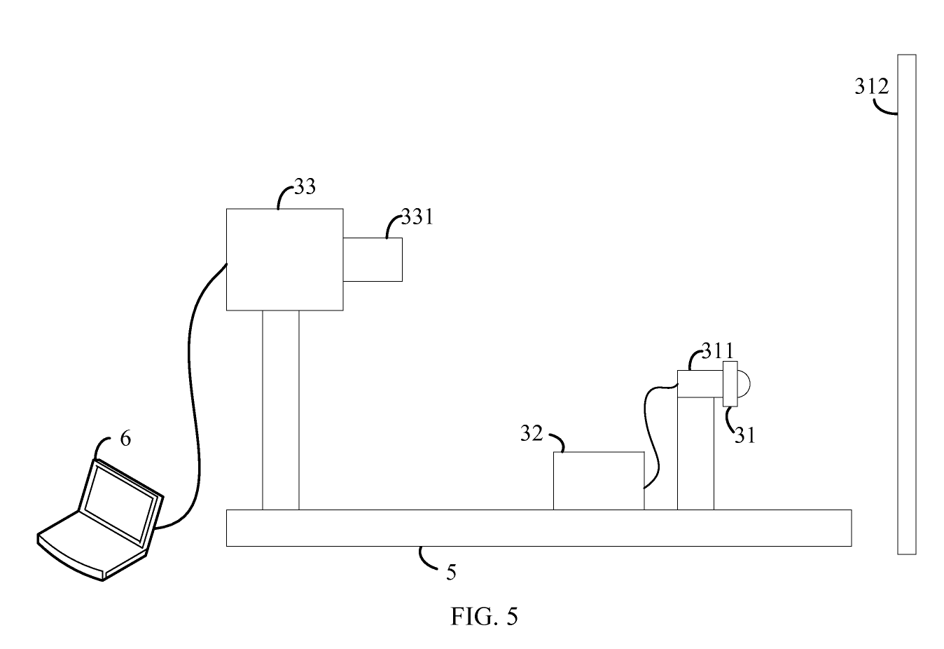

Referring to FIG. 5 which illustrates the second embodiment for the present invention of a white LED quality inspection method and device. As shown in FIG. 5, the present invention of a white LED quality inspection method and device comprises a white LED 31, a transformer 32, a screen 312, a digital camera 33 and a notebook computer 6 wherein the white LED 31, the transformer 32 and the digital camera 33 are installed on an optical table 5. The white LED 31 links the transformer 32 which supplies stable voltage and current necessary to white light emitted by the white LED 31 and projected on the screen 312. The screen 312 at a proper distance from the white LED 31 is intended for keeping uniformly attenuated luminance of a white light spot projected on the screen 312. As one tool for installation of the white LED 31, a support 311 allows heights and angles of the white LED 31 to be adjusted according to a position of the screen 312. The lens 331 of the image capture device 33 is opposite to the screen 312 and used to concentrate and focus white light on the screen 312 so that a photosensor (not shown in the figure) in the digital camera 33 transforms light signals to analog signals and further digital signals which are conveyed to the notebook computer 6. The notebook computer 6 comprises an image preprocessing module, a yellow hue calculation module and a yellow hue determination module (not shown in the figure) wherein the image preprocessing module transforms received digital signals to pixel information, the yellow hue calculation module calculates YRI of each pixel in the pixel information, and the yellow hue determination module judges any YRI out of specification.

The above descriptions are preferred embodiments of the present invention only but not intended to limit the scope of the present invention; any change and modification in the above described embodiments of the present invention can, of course, be carried out without departing from the scope thereof and limited only by the scope of the appended claims.

What is claimed is:

1. A white LED quality inspection method, comprising the steps of:
supplying a steady current to a white LED by a rated voltage supply unit to generate a stable light spot;
receiving said stable light spot by a photosensor of a luminous intensity sensing unit and transforming said stable light spot to a digital information;
receiving said digital information by a preprocessing unit and transforming said digital information to a pixel information; and
receiving said pixel information by a calculation unit to calculate a Yellow Ring Index of each pixel in said pixel information.

2. The white LED quality inspection method as recited in claim 1, wherein said calculation unit is a microprocessor and receives said pixel information to calculate said Yellow Ring Index of each pixel based on formulas as the following:
$${YRI}_{i , j} = f ( {Y}_{i , j} , {I}_{i , j} )$$
$$f ( Y , {I}_{i , j} ) = {Y}_{0} \times {I}_{0 , i , j}$$
$${Y}_{0 , i , j} = 1 - \frac{{B}_{i , j}}{{2}^{n}}$$
$${I}_{0 , i , j} = \frac{( {R}_{i , j} + {G}_{i , j} + {B}_{i , j} )}{3}$$
$$0 \leq {R}_{i , j} , {G}_{i , j} , {B}_{i , j} \leq {2}^{n}$$
wherein, YRI_{i,j} as said Yellow Ring Index of each pixel is the function of ƒ(Y_{i,j}I_{i,j}); R ,G, and B mean three primary colors (red, green and blue) of each pixel in said pixel information; n depends on a resolution scope of said luminous intensity sensing unit; i, j are a horizontal coordinate and a vertical coordinate of each pixel in said pixel information, respectively.

3. The white LED quality inspection method as recited in claim 1, wherein said white LED is installed on a support which depends on said luminous intensity sensing unit to adjust heights and angles of said white LED.

4. The white LED quality inspection method as recited in claim 1, further comprising steps of:
installing a luminous intensity attenuation unit in front of said luminous intensity sensing unit to attenuate luminance of said stable light spot out of said white LED.

5. The white LED quality inspection method as recited in claim 1, further comprising steps of:
Concentrating and projecting said stable light spot on said photosensor by means of an optical lens unit of said luminous intensity sensing unit.

6. The white LED quality inspection method as recited in claim 1, further comprising steps of:
Receiving said Yellow Ring Index of each pixel by a yellow hue determination unit of said calculation unit to determine whether said Yellow Ring Index out of a standard value.

7. A white LED quality inspection device, comprising:
a white LED, coupled to a rated voltage supply unit and the white LED supplied a steady current to said white LED to generate a stable light spot;
a luminous intensity sensing unit, further comprised a photosensor which received said stable light spot from said white LED and transformed said stable light spot to a digital information;
a preprocessing unit, coupled to said luminous intensity sensing unit and received said digital information which will be further transformed to a pixel information; and
a calculation unit, coupled to said preprocessing unit to receive said pixel information and calculate Yellow Ring Index of each pixel in said pixel information.

8. The white LED quality inspection device as recited in claim 7, wherein said calculation unit is a microprocessor and receives said pixel information to calculate said Yellow Ring Index of each pixel based on formulas as following:
$${YRI}_{i , j} = f ( {Y}_{i , j} , {I}_{i , j} )$$
$$f ( Y , {I}_{i , j} ) = {Y}_{0} \times {I}_{0 , i , j}$$
$${Y}_{0 , i , j} = 1 - \frac{{B}_{i , j}}{{2}^{n}}$$
$${I}_{0 , i , j} = \frac{( {R}_{i , j} + {G}_{i , j} + {B}_{i , j} )}{3}$$
$$0 \leq {R}_{i , j} , {G}_{i , j} , {B}_{i , j} \leq {2}^{n}$$
wherein, YRI_{i,j} as said Yellow Ring Index of each pixel is the function of ƒ(Y_{i,j}I_{i,j}); R ,G, and B mean three primary colors (red, green and blue) of each pixel in said pixel information; n depends on a resolution scope of said luminous intensity sensing unit; i, j are a horizontal coordinate and a vertical coordinate of each pixel in said pixel information, respectively.

9. The white LED quality inspection device as recited in claim 7, wherein said white LED is installed on a support which depends on said luminous intensity sensing unit to adjust heights and angles of said white LED.

10. The white LED quality inspection device as recited in claim 7 further comprises a luminous intensity attenuation unit which is installed in front of said luminous intensity sensing unit to attenuate luminance of said stable light spot out of said white LED.

11. The white LED quality inspection device as recited in claim 7, wherein said luminous intensity sensing unit further comprises an optical lens unit which concentrates and projects said stable light spot on said photosensor.

12. The white LED quality inspection device as recited in claim 7, wherein said calculation unit further comprises a yellow hue determination unit which determines whether said Yellow Ring Index is out of specification.
